(19) United States
(12) Patent Application Publication
(10) Pub. No.: US 2016/0052440 A1
(43) Pub. Date: Feb. 25, 2016

(54) ELECTRIC DUMPER VEHICLE

(71) Applicant: DUBLIN CITY UNIVERSITY, Dublin (IE)

(72) Inventors: Paul Samuel Fleming Young, Bray (IE); Francis Anthony Byrne, Lusk (IE); Alexander Philip Murphy, Dublin (IE); Sean Breen, Portlaoise (IE)

(21) Appl. No.: 14/783,634

(22) PCT Filed: Apr. 3, 2014
(86) PCT No.: PCT/EP2014/056749

§ 371 Date: Oct. 9, 2015

(30) Foreign Application Priority Data
Apr. 12, 2013 (GB) 1306671.7

(51) Int. Cl. B60P 1/34; B60P 1/16; B62D 61/06; B60K 1/02; B60L 11/18

(52) U.S. Cl. CPC B60P 1/34; B60K 1/02; B60L 11/1877; B62D 61/065; B60P 1/16

(57) ABSTRACT

The present teaching provides a three wheel zero emission dumper vehicle, the vehicle comprising a chassis, the chassis supporting: two fixed front wheels, a single steering rear wheel, and a load carrying assembly, wherein the vehicle is configured such that a distribution of weight supported by the chassis is such that a centre of gravity of the vehicle is maintained within a triangle formed by the contact of the wheels on the ground in both loaded and unloaded states of the load carrying assembly.

### FIELD

The present application relates to dumper vehicles for indoor and outdoor working environments.

### BACKGROUND OF THE INVENTION

A dumper vehicle or dumper is a vehicle designed for carrying bulk material, often on building sites. Within the context of the present teaching dumpers are distinguished from dump trucks by configuration: a dumper will be considered as being of the type of vehicle having a load skip in front of the driver, while a dump truck has its cab in front of the load. The load skip or skip may be configured to be elevated above the chassis and dump the load. Dumpers are normally diesel powered. Dumpers with rubber tracks are used in special circumstances for use on rough terrain.

Early dumpers were provided in a 2-wheel drive configuration, being driven on the front axle and steered at the back wheels. A single cylinder diesel engine was started by hand cranking. The steering wheel turned the back wheels, not front. The skip was secured by a catch by the driver's feet. When the catch was released, the skip tipped under the weight of its contents at pivot points below, and after being emptied was raised by hand.

One of the problems faced by designers of dumper vehicles is that of ensuring stability of the vehicle particularly when the vehicle is being steered when driving over uneven, steep or unstable ground. The problem can be more difficult to overcome in small dumper vehicles of the kind used on small building sites where users require a fairly substantial skip to carry material whilst the vehicle itself must remain of small size to be sufficiently manoeuvrable in such locations.

Modern dumpers have payloads of up to 10 tonnes and usually steer by articulating at the middle of the chassis (pivot steering). Such dumpers may have multi-cylinder diesel engines, some turbocharged, and may comprise electric controls and hydraulics for tipping and steering. A Roll-Over Protection frame may be fitted over the seat to protect the driver if the dumper rolls over. Some dumpers have Falling Object Protection (FOPS) as well. Lifting skips are available for discharging above ground level.

Dumper vehicles may be required to be relatively heavy, particularly since they commonly use heavy counterweights to balance the load carried by the tip. Typically, the front wheels of such vehicles are supported on a wheel bearing means. Since loads may be picked up outside the base area of the vehicle, a load moment will arise which might cause the dumper vehicle to tilt about the front axle. The load moment has to be compensated for by a corresponding righting moment. This righting moment is served by the dead weight of the vehicle that can be increased by separate counterweights at the other end of the vehicle. Thus, a defined working load of the dumper vehicle is opposed by a relatively large dead weight which requires to be accelerated and decelerated again during each driving and braking action, thereby increasing power requirements. Also, the dead weight will increase the resistance to vehicular motion as well as the loads imposed on the wheel. In addition such dead weight presupposes a sufficient load-carrying capacity of the floor or surface upon which the vehicle is disposed. Therefore, if lifting heights are larger the ultimate load admissible requires to be reduced as otherwise the stability of the vehicle will be jeopardized, especially when the load is lifted.

In view of the above necessity for counterweights, dumper vehicles cannot easily be transported from one site to another. This is a serious disadvantage in many applications, since dumper vehicles are commonly required for loading and unloading sod, bricks, construction materials and the like at locations where it would be uneconomic to maintain a dumper vehicle present at all times. In a solution to the problem of requiring a heavy counterweight to balance loads carried by dumper vehicles, U.S. Pat. No. 6,398,480 describes dynamically adjusting the distance between the wheels to adjust the centre of gravity when carrying a load. Other solutions involve placing limitations on vehicles when carrying a load, examples of which are disclosed in US2007/080025, US 2012/239261 and CA 2638085.

There is currently a large market for 2 ton and larger internal combustion engine dumpers for outdoor construction sites worldwide. This market is adequately supplied by a number of manufacturers.

However there is a significant requirement for 0.5-2.0 tonne electric dumper trucks that can be used in indoor locations such as hospitals, libraries, pharmaceutical plants or any other environment where zero emissions and low noise are important.

U.S. Pat. No. 6,887,029B1 discloses a three-wheeled, electrically powered cart for transporting items typically transported using a hand truck. The cart comprises a body section housing rechargeable batteries and a steerable load section that is hinged to the body section. An electric motor powers the front wheel for propelling the cart. The load section pivots about a generally vertical axis and has a movable load rack that pivots about a horizontal axis. A platform is located between the two rear wheels for supporting a user during operation. In one embodiment, the width of the cart is approximately 24 inches, allowing the cart to pass through a typical doorway.

Currently however there are no 1-tonne dumpers available on the market which are capable of operating in environments where noise and noxious gas emissions are prohibited. Such sites are characterised by the restricted working space requiring high manoeuvrability from the vehicle coupled with the ability to cope with transition to outdoor rough and unstable terrain.

Four main requirements technology requirements have been set for 1 tonne capacity dumper systems. These requirements include the working environment, drive and power-train, and EU regulations and directives on zero emissions and low noise requirements in public sites where such vehicles are to be used. In 1996 the European Commission issued a Green Paper in which it was stated that an estimated 20% of EU citizens were exposed to noise levels that scientists and health experts considered to be unacceptable, at which most people become annoyed, sleep is disturbed and health may be at risk.

EU regulation mainly comes from the Directive 2005/88/EC of the European Parliament and of the council of 14 Dec. 2005 amending Directive 2000/14/EC on the approximation of the laws of the Member States relating to the noise emission in the environment by equipment for use outdoors. While the requirements for the EU seem more lenient, there are stricter time controlled dB values of 52 dB and 45 dB for overtime and night operations in Ireland and UK for larger-sized dumpers.

According to the European Enterprise and Industry Website, diesel and spark emission engines installed in non-road mobile machinery (NRMM) such as excavators, bulldozers, front loaders, back loaders, compressors contribute greatly to air pollution by emitting carbon oxide (CO), hydrocarbons (HC), nitrogen oxides (NOx) and particulate matters. In line with the EU environmental policy it is the objective to progressively reduce the emissions and to phase out polluting equipment. Emissions from these engines are regulated before they are placed on the market by four directives: the Directive 97/68/EC, amended by the Directive 2002/88/EC, by the Directive 2004/26/EC and by the Directive 2006/105/EC.

Less than one tonne capacity dumper systems currently exist and meet present noise and emission regulations. However, 1 tonne and above systems are mainly outdoor systems of which none have zero emission status or indoor use technologies. Thus, there is a requirement for a 1 tonne capacity vehicle which is operable in indoor and outdoor environments, and which has a drive system configured to comply with zero emission specifications and noise directives.

In another requirement, a small turning radius is required to be able to manoeuvre in tight corners. In work environments such as indoor construction, hospitals malls etc., skid steering is not allowed as the tires leave a lot of rubber on the floor because of friction. Such tire marks are very difficult to get rid of and clean. In addition, tracked and skid steer vehicles need significant power requirements for turning.

For these reasons and others, there is a need for a dumper vehicle that can operate in a confined space where noise and noxious gas emissions are prohibited and which provides stability of movement in both indoor and outdoor environments over a range of terrains, and which is configured to carry loads of between 0.5 and 2 tonnes.

### SUMMARY

Accordingly, a first embodiment of the application provides a dumper vehicle as detailed in claim 1. Advantageous features are provided in the dependent claims.

### BRIEF DESCRIPTION OF THE DRAWINGS

The present application will now be described with reference to the accompanying drawings in which: FIG. 1 is a side view of the dumper vehicle according to an embodiment of the present teaching;

FIG. 2 illustrates a front view of the dumper vehicle;

FIG. 3 illustrates a rear view of the dumper vehicle;

FIG. 4 illustrates an isometric view of a chassis of the dumper vehicle, according to one embodiment of the present teaching;

FIG. 5 is a front perspective view of the dumper vehicle according to an embodiment of the present teaching;

FIG. 6 is a bottom plan view of the dumper vehicle showing a central space defined between panniers for housing batteries for powering the motors;

FIG. 7 is a perspective view of the dumper vehicle in a fully assembled configuration; and

FIG. 8 illustrates a hydraulic system for operating a load carrying skip of the dumper vehicle, according to an embodiment of the present teaching; and

FIG. 9 illustrates the turning motion for a dumper vehicle according to the present teaching.

### DETAILED DESCRIPTION OF THE DRAWINGS

Exemplary arrangements of an electric dumper vehicle provided in accordance with the present teaching will be described hereinafter to assist with an understanding of the benefits of the present teaching. Such a vehicle will be understood as being exemplary of the type of vehicle that could be provided and is not intended to limit the present teaching to any one specific arrangement as modifications could be made to that described herein without departing from the scope of the present teaching.

The present teaching provides a three-wheeled zero emission electric dumper vehicle. The dumper vehicle includes a chassis supporting two fixed front wheels and a single steering rear wheel, wherein all three wheels are driven individually by respective electric motors. The chassis also supports a load carrying assembly, or skip, for carrying loads, wherein the vehicle is configured such that a distribution of weight supported by the chassis is such that a centre of gravity of the vehicle is maintained, during normal operating conditions, within a triangle formed by the contact of the wheels on the ground in both loaded and unloaded states of the load carrying assembly. Within the context of the present teaching the term normal operating conditions is defined by the intended environment within which the vehicle will operate. Given the examples above of having to operate both in an indoor and outdoor environment it will be appreciated that in operation the vehicle will be required to deal with graded inclines and rough terrain. With the skip in the lowered position resting on the chassis (the travelling configuration), a vehicle provided in accordance with the present teaching is capable of travelling directly up and down gradients up to 45% gradient (about 25 degrees incline) safely in loaded and unloaded conditions at controlled speeds. It will be appreciated that the control of the speed is effected by having a motor capable of restraining acceleration of the vehicle during passage on terrain of this nature. Typical operating speeds of a vehicle in accordance with the present teaching will be no faster than about 8 km/h. Side slopes may be traversed up to 35% gradient (about 20 degrees incline), and rough terrain may also be traversed safely where the inclination of the vehicle remains within the 45% gradient in the longitudinal direction and the 35% gradient in the transverse direction. With the skip in the raised position it will be appreciated that the centre of gravity of the vehicle is raised and this effective increase in the height of the centre of gravity means that movement of the vehicle must be restricted to small, very slow adjustments of position. Such speed will be analogous of a limp mode of conventional electric vehicles where the speed is reduced to about 10% of the typical operating speeds. The capacity to constrain or restrict speeds or adjustment of position dependent on the orientation of the vehicle can be controlled through use of drive-by-wire control systems.

From the above, it will therefore be appreciated that the term normal operating conditions, in the context of the present teaching, will have different characteristics dependent on whether the skip is in its lowered or raised configuration. In a lowered configuration the vehicle is capable of maintaining the centre of gravity within the triangle formed by the contact of the wheels on the ground in both loaded and unloaded states of the load carrying assembly during periods where the vehicle remains orientated within the 45% gradient in the longitudinal direction and the 35% gradient in the transverse direction and this should be considered the normal operating conditions of the vehicle. It will be appreciated that these conditions are related to the size and capacity of the vehicle and in one preferred arrangement a dumper vehicle provided in accordance within the present teaching is configured to carry loads of between 0.5 and 2 tonnes and configured to be operable at gradients of up to 45% and is sized to fit through openings of 1 metre width.

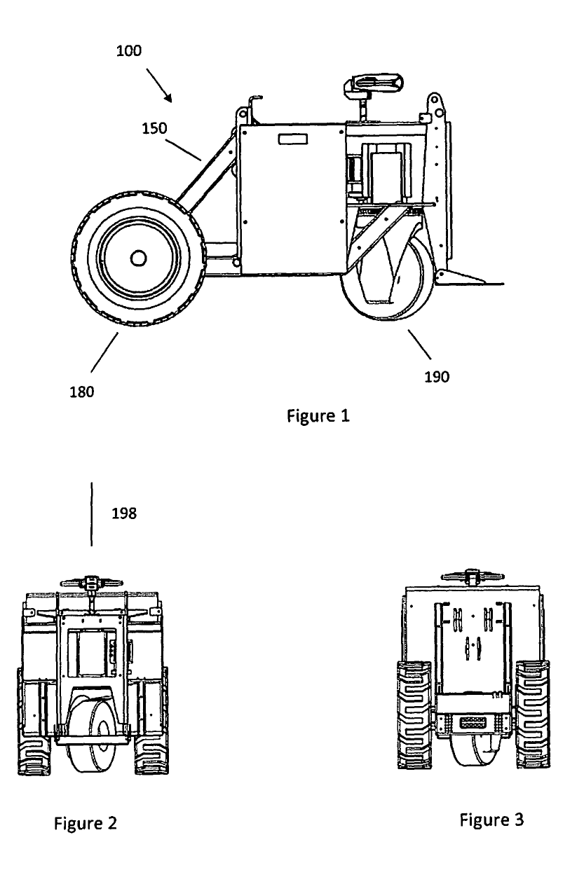

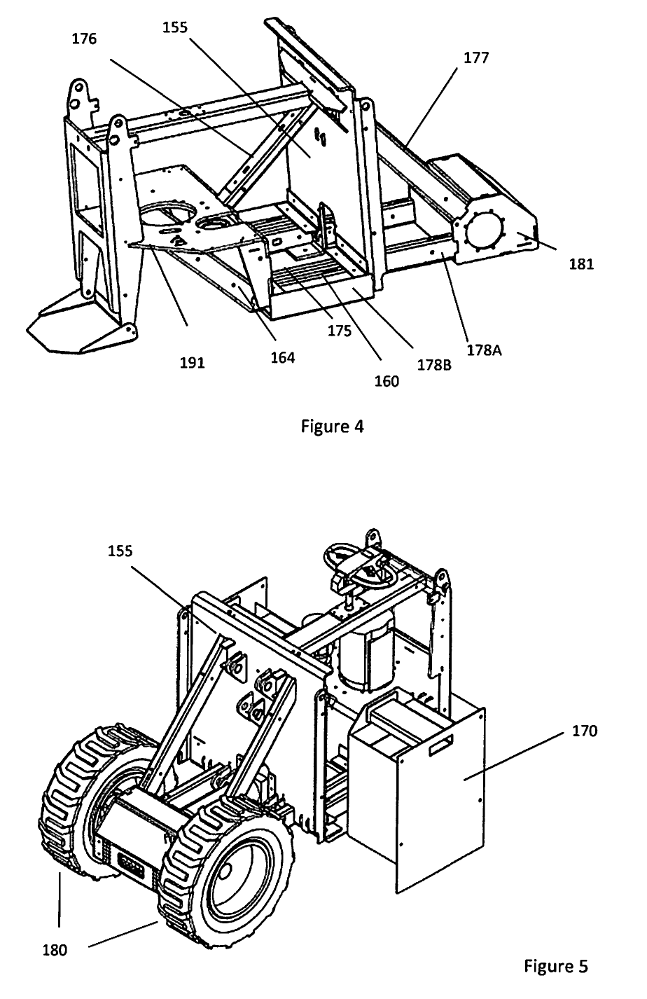

FIG. 1 is a side view of the dumper vehicle 100 according to an embodiment of the present teaching. FIGS. 2 and 3 illustrate front and rear views of the dumper vehicle 100 and FIG. 4 illustrates an isometric view of the dumper 100. The dumper vehicle 100 comprises a chassis 150 with two fixed direction wheels 180 at the front and a single rear wheel 190 at the rear of the chassis 150. Each of the wheels 180, 190 is driven by a separate electric motor. Referring to FIG. 2, the orientation of the rear wheel 190 may be controlled by a fourth motor driving a gear which rotates the rear wheel axle about an axis 198 substantially perpendicular to a plane defined by the triangular orientation of the front and rear wheels 180, 190. Thus, the rear wheel 190 functions to steer the dumper vehicle 100. This configuration allows the use of a rigid chassis without the need for a hinging pivot commonly found in current diesel powered dumper vehicles. The provision of a three-wheeled configuration, a separate motor for each of the front and rear wheels 180, 190 and the rotation of the rear wheel 190 in the substantially vertical plane enables ease of movement and manoeuvrability of the dumper vehicle 100 in restricted working spaces. In addition, the front and rear wheels 180, 190 can be driven individually or collectively. Each of the front and rear wheels 180, 190 may comprise a pneumatic tire for ensuring grip and flexibility.

It will be appreciated that the use of a three-wheeled configuration allows the dumper vehicle 100 to turn close to its axes of movement. The lack of emissions and low noise of the vehicle due to use of electric motors mean that the dumper vehicle 100 is configured to meet noise and emission regulations. This ensures that the dumper vehicle may be used safely indoors. However as the dumper vehicle 100 is also intended for use in construction/demolition environments it does not require a smooth floor surface. In order for this to be achieved, the configuration of the dumper vehicle 100 in terms of the wheel locations, battery location, payload location and attachment points is designed to ensure stability in rough environments. It will be appreciated that rough conditions within the constraints of the present teaching will be within the constraints of the normal; operating conditions defined above. As mentioned above, each of the front and rear wheels 180, 190 may comprise a pneumatic tire for ensuring grip and flexibility in rough terrain.

The main component of the dumper vehicle 100 is the chassis 150 which is configured to provide sufficient structural torsional and bending rigidity. The chassis 150 is designed to ensure that the completed assembled dumper vehicle 100 has a compact and lightweight structure. FIG. 4 shows an example of a chassis 150 that may be used, according to one embodiment of the present teaching.

The chassis 150 is configured to provide a stable platform for the dumper vehicle 100 throughout the range of motion of the lifting mechanisms of the load carrying assembly in loading and unloading positions. Actuators for activating the load carrying assembly will be described later. Referring to FIG. 4, the chassis 150 may include a central bulkhead 155 between the front and rear of the chassis 150. The central bulkhead 155 may be in the form of a plate extending in a substantially perpendicular direction to a plane defined by the front and rear wheels 180, 190. The central bulkhead 155 may also extend laterally with respect to a longitudinal axis of the vehicle, as illustrated in FIG. 4. The central bulkhead 155 is thus configured to provide both vertical and lateral strength to the chassis 150 and thus to the overall dumper vehicle 100. The chassis 150 may define an area for receiving batteries for powering the motors which drive the front and rear wheels 180, 190. A drive system for operating the load carrying assembly may also be housed in this area. The drive system for operating the load carrying assembly may in one embodiment comprise an electric driven hydraulic powerpack. In this regard, the batteries and the drive system for operating the load carrying assembly may be housed on a platform 160 in the chassis 150. The height of the platform 160 is configured such that when the batteries and drive system are received on the platform 160, the centre of gravity of the dumper vehicle 100 is positioned as low as possible to the ground. To this end, the platform 160 may define a plane disposed below an axis of rotation of the front wheels 180 and/or above a horizontal axis of rotation of the rear wheel 190. The location of the batteries and the distribution of the weight in the dumper vehicle 100 are configured to allow the operation of a high lift skip on the front of the dumper vehicle 100 while ensuring stability. When carrying a full payload, the balance of the dumper vehicle 100 is maintained with the skip in its lowered travelling position by providing the distribution of weight within the vehicle such that the location of the centre of gravity of the dumper vehicle 100 as close to the ground as possible.

FIG. 5 is an isometric view of the chassis 150 of the dumper vehicle 100, according to one embodiment of the present teaching. The view in FIG. 5 is from a perspective at the front of the dumper vehicle 100. As illustrated, the two front wheels 180 are located forward of the central bulkhead 155. To ensure optimal distribution of weight the present teaching advantageously provides for a mounting of batteries in two panniers 170 which may be presented to the dumper vehicle 100 immediately behind the bulkhead 155 from either side of the vehicle. The panniers 170 may comprise first and second panniers, each of the first and second panniers being configured to receive batteries. Each of the panniers is moveable relative to the chassis 150 between a supported and a non-supported position. In the non-supported position a user is provided with access to a pannier to allow a loading or unloading of the batteries within the pannier and in a supported position the panniers are supported on the platform.

Each of the panniers 170 may be moved from opposite sides of the vehicle between their respective supported and non-supported positions. The panniers 170 may be co-operable with a forklift blade or suitable hoist so as to allow a movement of the panniers between the supported and non-supported positions. The panniers 170 may comprise a socket dimensioned to receive the lifting arm of the forklift. It will be appreciated that the weight of batteries necessary to provide sufficient power for an electric zero emission vehicle is significant and by advantageously separating the batteries into first and second panniers which are individually located relative to the chassis it is possible to effectively ensure the distribution of weight to ensure that the centre of gravity is maintained, during normal operating conditions of the vehicle, within the triangle formed by the contact of the three wheels on the ground on which the vehicle is travelling. Exemplary implementations require 8 batteries of 50 kg each having dimensions of 600 mm×250 mm×150 mm but it will be appreciated that these parameters will vary dependent on the performance of the vehicle and dimensions available for storage of same and battery technology.

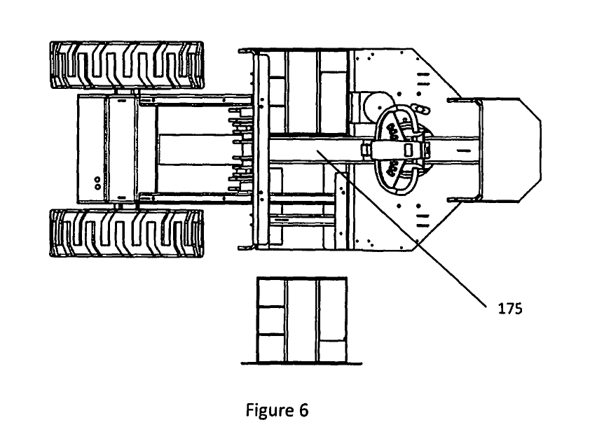

The above-described configuration allows the centre of gravity of the loaded and unloaded vehicle to be maintained within the triangle formed by the contact of the wheels 180, 190 on the ground. The panniers 170 may be configured such that a central space 175 is defined therebetween, as illustrated in the bottom plan view of FIG. 6. The drive system for the load carrying assembly may be housed in the central space 175 on the platform 160. By positioning the weight of the drive system and the batteries on the same level and as close to the ground as possible, the centre of gravity of the dumper vehicle is located towards the base of the vehicle, thereby providing stability. The positioning of the drive components, batteries and other ancillary devices therefore stabilises the overall vehicle and obviates the need for any separate counterweight. Thus, the overall weight of the vehicle is kept to a minimum, which is an advantage in terms of portability.

Referring back to FIG. 4, an inclined structural member 176 providing support to the rear of the central bulkhead 155 may be accommodated in the central space 175. The inclined structural member 176 may extend from the rear of the central bulkhead 155 to a rear wheel mounting plate 191. The rear wheel mounting plate 191 may also house a motor for driving the rear wheel 190 and the fourth motor for rotating the rear wheel axle about an axis substantially perpendicular to a plane defined by the triangular orientation of the front and rear wheels 180, 190. Additionally the central bulkhead 155 may be supported to the front by two inclined structural members 177 extending to a front axle box 181. The front axle box 181 may house the front axle and motors for driving the front wheels 180. Two outer horizontal members 178A may run longitudinally from the front axle box 181 to the central bulkhead 155 at the lowest possible level to support the weight of the batteries from beneath. Two inner horizontal members 178B may extend in parallel to the outer horizontal members 178A under the batteries before rising to the rear wheel mounting plate 191. The inner horizontal members 178B and outer horizontal members 178A may be connected to the central bulkhead 155. The inner horizontal members 178B define the platform 160. The platform 160 may be bounded to the front by the central bulkhead 155 and to the rear by a plate 164 extending from the inner horizontal members 1788 to the rear wheel mounting plate 191.

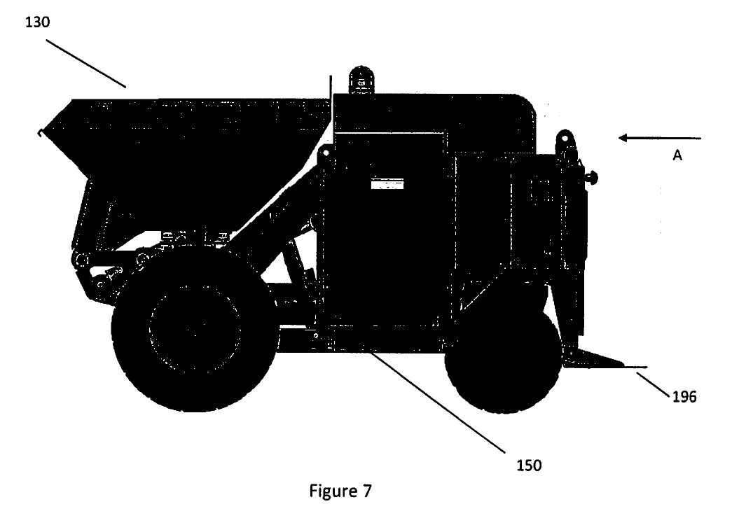

FIG. 7 is a perspective view of the dumper vehicle in a fully assembled configuration. The dumper vehicle 100 may comprise a load carrying skip 130 mounted on the chassis 150. The load carrying skip 130 may be designed to carry loads of between 0.5 and 2 tonnes. The load carrying skip 130 is movable relative to the chassis 150 to enable carried loads to be dumped therefrom. In the illustrated embodiment, the load carrying skip 130 is pivotable about a horizontal tipping axis generally in the direction of an arrow A to permit the dumping of loads therefrom. As is clearly illustrated in FIG. 7, the load carrying skip 130 may be mounted on the chassis 150 in front of a platform 196 on which an operator stands when operating the dumper 100. In other embodiments, the platform 196 may be retractable so that the platform 196 can be folded against a rear of the dumper vehicle 100 when not in use. In embodiments of the present teaching, the load carrying skip 130 may also be rotatable about a vertical axis to permit the sideways dumping of loads from the load carrying skip 130. In other embodiments the load carrying skip 130 may be lower than the height of the operator controls. Other arrangements may have a longer skip in the longitudinal direction of the vehicle.

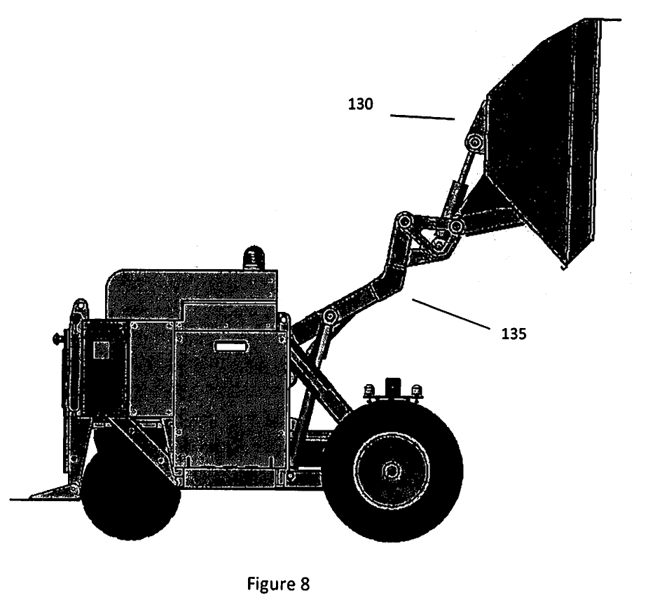

The load carrying skip 130 may be actuated by a hydraulic system powered by an electric motor driven hydraulic power pack. Referring to FIG. 8, the hydraulic system may comprise hydraulic cylinders, rams and a lifting arm 135 for tipping the skip 130 in a manner that would be understood by the skilled person. A hydraulic liquid for actuating the hydraulic components 135 may be provided by a transmission operated oil pump which draws oil from a reservoir and may be controlled by the operator. Pressurised liquid from the pump may pass through a flexible coupling to a main distributing valve which can be set to supply the pressurised liquid through the flexible coupling to the hydraulic components 135 for tipping the skip 130.

Movement of the mechanisms required for the dumper vehicle 100 to empty its load from the skip 130 is enabled through the use of an electric motor driven hydraulic power pack supplying power to the hydraulic rams. The hydraulic power pack may comprise a motor mounted between the inner horizontal members 161. The motor may occupy some of the central space 175 between the panniers 170 to ensure the centre of gravity is as low as possible. The oil reservoir for the hydraulics 135 may be positioned in front of the central bulkhead 155 between the outer horizontal members 178. The attachment points for the mechanisms of the chassis 150 described above are all affixed to the central bulkhead 155. Thus, the central bulkhead 155 provides both vertical and lateral stability to the chassis 150.

The chassis 150 may be designed and analysed using CAD and CAE software for torsional rigidity and stiffness, and vibration and modal analysis for when the vehicle is moving over rougher terrain. It will be appreciated that while several embodiments of the chassis design have been described above, the present teaching should not be construed as being limited to these particular arrangements. Any chassis design which results in a chassis which maintains contact of all of the wheels on the ground in both loaded and unloaded states of the load carrying assembly is possible within the limits of the present teaching.

The centre of gravity of the vehicle is maintained within a triangle formed by the contact of the wheels on the ground in both loaded and unloaded states of the load carrying assembly.

The dumper vehicle 100 according to the present teaching may be configured to be operated in a number of ways. In one embodiment, the dumper vehicle may be controlled by drive-by-wire technology. For example, an operator may walk beside or behind the dumper and operate it by remote control. The dumper vehicle may be towed by another vehicle. In another arrangement, the dumper may comprise a retractable platform to the rear of the vehicle to allow an operator to hop on/off the vehicle. The dumper vehicle may be operated by an operator standing on the platform using joy stick power assisted steering.

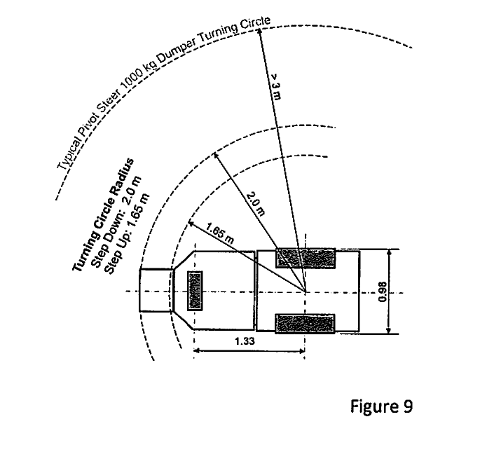

The dumper vehicle 100 according to the present teaching is configured for ease of manoeuvrability. As described above, the dumper vehicle 100 according to the present teaching has a rear steering wheel 190 and two front wheels 180. It will be appreciated by those of skill in the art that three wheel vehicles typically always turn about a centre on the line defined by the rotational axis of the front wheels. FIG. 9 illustrates the turning motion for a dumper vehicle according to the present teaching. At small steering angles this point is distant from the vehicle to the inside of the turn and the inner wheel must rotate slower than the outer wheel. However, at the critical angle it lies directly at the location of the inner front wheel. At this steering angle, the inner wheel should not rotate on its axle. For larger steering angles, the centre of rotation will move between the inner wheel and the centre line of the vehicle, and the inner wheel should rotate in the reverse direction. This behaviour is well known and the standard control algorithms for the controllers used in drive-by-wire vehicles allow the setting of the parameters required to control this behaviour. This characteristic gives the vehicle high manoeuvrability in confined indoor spaces. The rate of turn is a forward velocity of the vehicle divided by the distance to the centre of the turn, and results in centripetal acceleration of the vehicle towards the centre A corresponding overturning moment results, which may be actively reduced by slowing the vehicle as the turn rate increases and this is also a feature of commercially available drive-by-wire controllers. The severity of this problem is reduced in a vehicle provided in accordance with the present teaching as the centre of gravity of the vehicle is lowered. The narrow width of the triangle formed by the wheels compared with the load requirements require optimised location of the structural elements to allow heavy components be installed as low as possible within the design.

By positioning the weight of the drive system and the batteries on the same level and as close to the ground as possible, the centre of gravity of the dumper vehicle is located towards the base of the vehicle, thereby providing stability. The positioning of the drive components, batteries and other ancillary devices therefore stabilises the overall vehicle and obviates the need for any separate counterweight. Thus, the overall weight of the vehicle is kept to a minimum, which is an advantage in terms of portability. The load carrying assembly may be driven by an electric driven hydraulic powerpack. The dumper vehicle has multi-terrain capability for indoor and outdoor use. The chassis may be designed in consideration of weight, portability size, weight and volume capacity, drive, manoeuvring operation, and location of centre of gravities of the vehicle. In one configuration of a dumper vehicle provided in accordance with the present teaching the vehicle is configured to carry loads of between 0.5 and 2 tonnes and configured to be operable at gradients of up to 45% and is sized to fit through openings of 1 metre width.

The words comprises/comprising when used in this specification are to specify the presence of stated features, integers, steps or components but does not preclude the presence or addition of one or more other features, integers, steps, components or groups thereof.

While the present teaching has been described with reference to some exemplary arrangements it will be understood that it is not intended to limit the present teaching to such arrangements as modifications can be made without departing from the spirit and scope of the present teaching. In this way it will be understood that the present teaching is to be limited only insofar as is deemed necessary in the light of the appended claims.

1. A three wheel zero emission dumper vehicle, the vehicle comprising a chassis, the chassis supporting:
two fixed front wheels;
a single steering rear wheel; and
a load carrying assembly,
wherein the vehicle is configured such that a distribution of weight supported by the chassis is such that a centre of gravity of the vehicle is maintained within a triangle formed by the contact of the wheels on the ground in both loaded and unloaded states of the load carrying assembly.

2. The vehicle of claim 1, comprising first, second and third electric motors supported by the chassis and wherein each of the three wheels is driven independently by a separate one of the first, second and third electric motors, the motors being arranged within the vehicle to maintain the centre of gravity within the triangle formed by the contact of the wheels on the ground in both loaded and unloaded states of the load carrying assembly.

3. The vehicle of claim 1, wherein the chassis defines a platform configured to house batteries for powering the vehicle.

4. The vehicle of claim 3, comprising first and second panniers, each of the first and second panniers being configured to receive batteries, each of the panniers being moveable relative to the chassis between a supported and a non-supported position and wherein in a non-supported position a user is provided with access to a pannier to allow a loading or unloading of the batteries within the pannier and in a supported position the panniers are supported on the platform.

5. The vehicle of claim 4 wherein the each of panniers are moveable from opposite sides of the vehicle between their respective supported and non-supported positions.

6. The vehicle of claim 4 or 5, wherein, in a supported position, the panniers are configured to define a central space therebetween.

7. The vehicle of claim 3, wherein the platform defines a plane disposed below an axis of rotation of the front wheels and/or above a horizontal axis of rotation of the rear wheel.

8. The vehicle of claim 1, wherein the load carrying assembly comprises a drive system for driving the load carrying assembly.

9. The vehicle of claim 8, wherein the drive system is located in the central space on the platform.

10. The vehicle of claim 1, wherein the load carrying assembly comprises a hydraulic raised tipping system.

11. The vehicle of claim 10, wherein the hydraulic raised tipping system comprises a skip configured to carry a load, the skip configured to be elevated above the chassis and dump a load.

12. (canceled)

13. The vehicle of claim 8, wherein the drive system comprises an electric driven hydraulic powerpack.

14. The vehicle of claim 1, wherein the chassis comprises a central lateral bulkhead for providing both vertical and lateral strength to the chassis.

15. The vehicle of claim 14, wherein the central bulkhead is in the form of a plate extending in a substantially perpendicular direction to a plane defined by the front and rear wheels.

16. The vehicle of claim 14, wherein the central bulkhead extends in a lateral direction with respect to a longitudinal axis of the vehicle.

17. The vehicle of claim 14, wherein the chassis defines a platform configured to house batteries for powering the vehicle and wherein the platform is disposed immediately behind the bulkhead.

18. The vehicle of claim 14, wherein the central bulkhead extends in a lateral direction with respect to a longitudinal axis of the vehicle and wherein the chassis comprises an inclined structural member provided in the central space which provides support to the rear of the central lateral bulkhead.

19. The vehicle of claim 14, wherein the central bulkhead is supported to the front by two inclined structural members extending to a front axle box.

20. The vehicle of claim 19, wherein the front axle box is configured to house electric motors for driving the front wheels.

21. The vehicle of claim 19, wherein the chassis comprises two outer horizontal members running longitudinally from the front axle box and located relative to the panniers in a supported configuration to support the weight of the batteries from beneath the panniers.

22. The vehicle of claim 21, wherein the chassis comprises two inner horizontal members extending in parallel to the outer horizontal members before rising to a rear wheel mounting plate.

23. The vehicle of claim 22, wherein the chassis defines a platform configured to house batteries for powering the vehicle and wherein the two inner horizontal members define the platform.

24. The vehicle of claim 1, further comprising a fourth electric motor for driving a gear which rotates a rear wheel axle about an axis substantially perpendicular to a plane defined by the triangular orientation of the front and rear wheels, wherein the orientation of the rear wheel is controlled by the fourth motor.

25-26. (canceled)

27. The vehicle of claim 1, being operated by remote control.

28-33. (canceled)

34. The vehicle of claim 1, being configured to be operable at gradients of up to a 45% gradient while maintaining the centre of gravity within the triangle formed by contact of the three wheels on the ground.

35. The vehicle of claim 4, wherein the panniers are co-operable with a lifting arm of a forklift or hoist so as to allow a movement of the panniers between the supported and non-supported positions.

36. The vehicle of claim 34, wherein the panniers comprise a socket dimensioned to receive the lifting arm.

37. (canceled)
